(19) United States
(12) Patent Application Publication
(10) Pub. No.: US 2021/0287514 A1
(43) Pub. Date: Sep. 16, 2021

(54) METHOD FOR SHARING RISK STATUS OF USER USING TIMER AND APPARATUS THEREFOR

(71) Applicant: Kwangyoung CHANG, Seoul (KR)

(72) Inventor: Kwangyoung CHANG, Seoul (KR)

(21) Appl. No.: 16/480,879

(22) PCT Filed: Jan. 26, 2018
(86) PCT No.: PCT/KR2018/001174

§ 371 Date: May 25, 2021

(30) Foreign Application Priority Data
Jan. 26, 2017 (KR) 10-2017-0012480

(51) Int. Cl. G08B 21/04; G08B 21/22; G08B 25/10

(52) U.S. Cl. CPC G08B 21/0476; G08B 25/10; G08B 21/22; G08B 21/0492

(57) ABSTRACT

The present invention relates to a method for sharing risk status information of a user by using a timer, and an apparatus therefor. One embodiment of the present invention may comprise the steps of: receiving, from a user terminal, time range information for a countdown of a timer set by a user; executing the countdown of the timer during the time range when a request to execute the countdown of the timer is received from the user terminal; and sharing risk status information of the user with at least one predetermined recipient terminal, when a request to release the risk status is not received from the user terminal until the countdown is terminated from the time when the countdown was executed.

### TECHNICAL FIELD

The present invention relates to a method of sharing a risk status of a user by using a timer, and an apparatus therefor. More specifically, the present invention relates to a method of sharing information of a risk status of a user with one or more predetermined recipient terminals, in which a countdown of the timer is executed during a preset time range when a request to execute the countdown is input and, in particular, when a request to release the risk status is not received from the user before the timer is terminated, and an apparatus therefor.

### BACKGROUND ART

Recently, the incidence of crimes targeting women, children, and the elderly which are included in the category of the socially disadvantaged is rapidly increasing.

In particular, recently, it is expected that a decrease in probability of crimes targeting women, such as rape or an indecent act by force, is lowest in comparison with other crimes. According to the resident registration demographic data recently released by the Ministry of Government Administration and Home Affairs, the number of household heads in one household is 7,606,106, among which women in their 20s and 30s account for the largest portion. Therefore, it is predicted that the incidence of crimes targeting women among the socially disadvantaged will continue without decreasing.

In the past, most people including the above-described socially disadvantaged tend to refrain from going out or return home after the sunset. However, recently, as society has developed, the number of streetlights installed in signs and divisions of downtown areas is increasing. Such a phenomenon has brought about a great change in patterns of life in modern society so that more people tend to carry on outdoor activities until late hours.

As described above, the phenomenon that more people are engaged in outdoor activities until late hours provides an advantage of increasing the time available for people's outdoor activities but, on the other hand, it also acts as a cause for increasing the probability that people are exposed to the risk of crimes outdoors.

Ultimately, many people in the present age are faced with situations in which they may be exposed to various risks as victims of dangerous crimes, such as violence, robbery, murder, sexual assault, kidnapping, and the like.

As a result, recently, a large number of closed-circuit televisions (CCTVs) have been installed in various areas, such as residential areas and alleyways in addition to downtown areas and roads, thereby contributing to the prevention of crimes to some extent. However, the CCTVs are more often used for on-site analysis after the crimes than crime prevention, and thus an effect of crime prevention is still insufficient. Meanwhile, such crime cases occur mainly at night time, but there is not necessarily such time limit. In particular, crimes are occurring frequently regardless of specific time in places with a narrow range of exposure to people's view, such as elevators, alleyways, taxis, public restrooms, and private homes.

Conventionally, small-sized rescue request devices have been manufactured and distributed so that a victim who is in an emergency situation can request help from another person when the above-described crime occurs. However, there is a realistic difficulty for the victim to request help from another person in real time by using such devices in an urgent and confusing situation where a crime is occurring, and thus there is a problem in that its effectiveness is insufficient.

However, as described above, in the case of a crime that occurs in a situation in which a victim cannot anticipate, it may be very difficult to prevent or respond to the crime. In situations in which crimes occurring is somewhat expectable, such as a situation in which a person has to walk in a dark alleyway, a situation in which a person should return home by cab in the late night, a situation in which a visitor whose accurate identity is difficult to check arrives at a home, and the like, if a person pays special attention to himself or herself or takes measures to protect himself or herself in advance, he or she will be able to prevent the occurrence of such crimes, or he or she may be able to respond rapidly by requesting rapid protection.

As described above, in a situation in which a crime may be predicted to some extent, if he or she is only able to preemptively make a protection request when it is assumed that the case in which a crime does not occur is a release condition other than simply paying attention to himself or herself, the probability of such a crime occurring will be reduced as much as possible and the damage caused by the crime will be minimized even if the victim does not take any action at an urgent moment when the crime is occurring and is unable to make a separate request for protection. Therefore, the above-described solution for solving the above problems is required.

### DISCLOSURE

### Technical Problem

It is an object of the present invention to propose a method of sharing a risk status of a user by using a timer.

It is another object of the present invention to propose a method of sharing information of a risk status of a user with an external device when a request to release the risk status of the user is not input until a countdown of a timer, which is executed based on a predetermined criterion, is terminated.

The technical problems to be solved by the present invention are not limited to above-described objects, and other unmentioned technical problems may be clearly understood by those skilled in the art from the following descriptions.

### Technical Solution

One aspect of the present invention provides a method of sharing a risk status of a user by using a timer including receiving information of a time range of a countdown of the timer set by the user from a user terminal, executing the countdown of the timer during the time range when a request to execute the countdown of the timer is received from the user terminal, and sharing risk status information of the user with at least one predetermined recipient terminal when a request to release the risk status is not received from the user terminal before the countdown is terminated from a time point when the countdown was executed.

Another aspect of the present invention provides an apparatus for sharing a risk status of a user by using a timer including a communication unit configured to perform data communication with one or more user terminals and a control unit configured to control an operation of the apparatus sharing risk status information, wherein the control unit receives time range information of a countdown of the timer set by the user from the user terminal, the countdown of the timer is executed during a time range of the countdown when a request to execute the countdown of the timer is received from the user terminal, and the risk status information of the user is controlled to be shared with at least one predetermined recipient terminal when a request to release the risk status is not received from the user terminal before the countdown is terminated from a time point when the countdown was executed.

### Advantageous Effects

According to the present invention as described above, the following effects can be obtained. However, effects obtained through the present invention are not limited thereto.

First, according to the present invention, a method can be proposed for sharing a risk status of a user by using a timer.

Second, according to the present invention, a method can be proposed for sharing information of a risk status of a user with an external device when a request to release the risk status of the user is not input until a countdown of the timer, which is executed based on a predetermined criterion, is terminated.

Third, according to the present invention, a method can be proposed for sharing information of a risk status of a user, which includes a recorded voice and a recorded image, with an external device by activating a voice recording function and an image recording function of a user terminal when a request to release the risk status of the user is not input until a countdown of the timer, which is executed based on a predetermined criterion, is terminated.

Fourth, according to the present invention, a method of sharing a risk status of a user with an external device, when second password information or second fingerprint information other than predetermined first password information or predetermined first fingerprint information is input, can be provided, and thus the user at a risk can share his or her risk status with an external device despite pressure of a perpetrator.

Fifth, according to the present invention, by sharing information of a risk status of a user with an external device when there is a request from the user while a timer, which is executed based on a predetermined criterion, is running, a premise condition that the timer should be executed before sharing the risk status information with the external device can be included and it is possible to prevent the user from notifying the external device of the risk status due to a simple operation mistake.

Sixth, according to the present invention, various methods of executing a countdown of a timer can be proposed.

Seventh, according to the present invention, apparatuses for implementing the above methods can be provided.

The technical problems to be solved by the present invention are not limited to above-described objects, and other unmentioned technical problems may be clearly understood by those skilled in the art from the following descriptions.

### DESCRIPTION OF DRAWINGS

FIG. 1 is a view showing an example of a wired and/or wireless communication network environment to which the present invention may be applied.

FIG. 2 is a block diagram of a server (200) according to an embodiment of the present invention.

FIG. 3 is a flowchart for describing a method of sharing a risk status of a user by using a timer according to an embodiment of the present invention.

FIG. 4 shows views showing an example of a timer and an example in which the timer is executed based on a predetermined condition according to an embodiment of the present invention.

FIG. 5 shows views showing an example in which a timer is executed based on a predetermined condition according to another embodiment of the present invention.

FIG. 6 shows views showing an example in which a timer is executed based on a predetermined condition according to still another embodiment of the present invention.

FIG. 7 shows views showing an example in which a subject sharing a risk status is added according to an embodiment of the present invention.

FIG. 8 shows views for describing an online chat room which is established at the same time as timer execution according to an embodiment of the present invention.

FIG. 9 shows views showing examples of safety status information input by a user according to an embodiment of the present invention.

FIG. 10 is a view for describing a method of sharing risk status information, including location information, of a user with an external device according to an embodiment of the present invention.

FIG. 11 is a view for describing a method of sharing risk status information of a user with an external device when there is a request from the user while a timer is running according to an embodiment of the present invention.

FIG. 12 shows block diagrams of configurations of a user terminal and a server that perform an embodiment of the present invention.

### MODES OF THE INVENTION

Hereinafter, exemplary embodiments of the present invention will be described in detail with reference to the accompanying drawings. The detailed descriptions which are given below with reference to the accompanying drawings are intended to illustrate the exemplary embodiments of the present invention and are not intended to represent the only embodiments in which the present invention may be implemented.

The embodiments are provided in order to fully explain the present invention and fully explain the scope of the present invention for those skilled in the art. The scope of the present invention is defined by the appended claims.

In some cases, known structures and devices may be omitted or may be shown in block diagram forms based on the main functionality of each structure and device to avoid obscuring the concepts of the present invention. In addition, throughout this specification, the same components are denoted by the same reference numerals.

Throughout this specification, when a certain part “comprises or includes” a certain component, it means that another component may be further included not excluding another component unless otherwise defined.

Further, terms described in the specification such as “ . . . part,” “ . . . unit,” “module,” and “device,” refer to a unit of processing at least one function or operation and may be implemented by hardware or software or a combination thereof. Furthermore, the terms “a,” “an,” “one,” or the like may be used in the sense of including the singular and the plural, unless the context clearly dictates otherwise or the meaning is clearly contradicted by context.

In addition, specific terms used in embodiments of the present invention are provided to aid understanding of the present invention. Unless otherwise defined, all terms (including technical and scientific terms) used herein have the same meaning as commonly understood by one of ordinary skill in the art to which this invention belongs. The specific terms used herein may be modified to other forms without departing from the spirit of the present invention.

Hereinafter, exemplary embodiments of the present invention will be described in detail with reference to the accompanying drawings. The detailed descriptions which are given below with reference to the accompanying drawings are intended to illustrate exemplary embodiments of the present invention and are not intended to represent the only embodiments in which the present invention may be implemented.

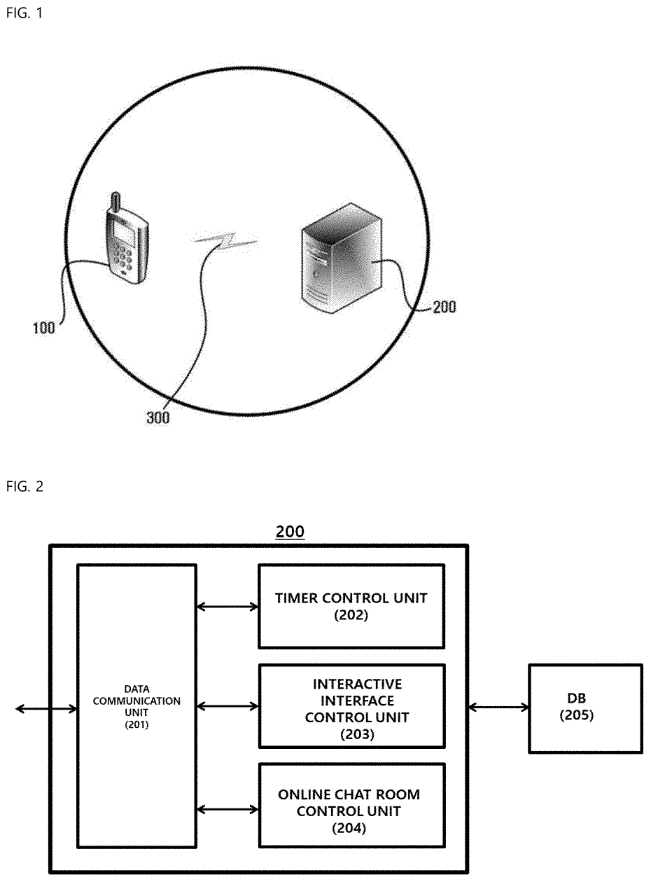

FIG. 1 is a view showing an example of a wired and/or wireless communication network environment to which the present invention may be applied.

Referring to FIG. 1, the wired and/or wireless communication network environment to which the present invention may be applied may include a user terminal 100, a server 200, and a network 300.

However, the wired and/or wireless communication network environment described below includes at least one of the components shown in FIG. 1, but the present invention is not limited thereto. In FIG. 1, only one user terminal, one server, and one network are shown. On the other hand, the wired and/or wireless communication network environment to which the present invention may be applied may include one or more user terminals, one or more servers (e.g., a management server, a mediation server, a relay server, and a client server) and one or more networks, and the respective user terminals and servers may be connected via different networks.

In the present invention, the user terminal 100 may be interpreted as a concept of a device capable of transmitting and receiving communication signals to and from other devices including the server 200.

In this case, one or more applications may be installed in the user terminal 100 in advance. In particular, applications including application program interfaces (APIs) or embedded software associated with the present invention may be installed in the user terminal 100.

That is, a method according to the present invention described below may be performed through applications including APIs or embedded software pre-installed in the user terminal 100 or a timer included in the application, but the present invention is not limited thereto, and the method may be performed through a website.

Meanwhile, the user terminal 100 may transmit or receive data or signals to or from the server 200 or may transmit or receive data or signals to or from the server 200 through the one or more applications.

In this case, the transmitted or received data or signals may be an application which is pre-installed in the user terminal for the present invention, but the present invention is not limited thereto.

Examples of the user terminal 100 may include a terminal device, a terminal, a mobile station (MS), a mobile subscriber station (MSS), a subscriber station (SS), an advanced mobile station (AMS), a wireless terminal (WT), a machine-type communication (MTC) device, a machine-to-machine (M2M) device, and a device-to-device (D2D) device.

Of course, these are merely examples, and the user terminal in the present invention should be construed as a concept including all devices that are currently developed, commercialized, or to be developed in the future, or capable of signal transmission.

Referring again to FIG. 1, the server 200 refers to an object capable of transmitting and receiving data to and from at least another device through the wired and/or wireless communication network environment. In the present invention, the server 200 may further include a mediation server and/or a client server.

Further, examples of the server 200 may include a cloud server, an Internet Protocol (IP) Multimedia Subsystem (IMS) server, a telephony application server, an instant messaging (IM) server, a media gateway control function (MGCF) server, a messaging gateway (MSG) server, and a call session control function (CSCF) server. The server 200 may be implemented as a device that refers to an object capable of transmitting and receiving data, such as a personal computer (PC), a notebook computer, and a tablet PC.

Meanwhile, the network 300 refers to a data communication network for transmitting and receiving various types of data, such as text, digital images, digital videos, and digital voice information, between the user terminal 100 and the server 200, and the type of the data is not particularly limited.

For example, the network 300 may be an IP network that provides a service for transmitting/receiving a large amount of data through IP or may be an all IP network in which different IP networks are integrated.

Further, the network 300 may be one of a wired network, a wireless broadband (WiBro) network, a mobile communication network including Wideband Code Division Multiple Access (WCDMA), a mobile communication network including High Speed Downlink Packet Access (HSDPA) network and a Long-Term Evolution (LTE) network, a mobile communication network including LTE advanced (LTE-A), a satellite communication network, and a Wi-Fi network, or may be configured by combining one or more networks of the above networks.

FIG. 2 is a block diagram of a server 200 according to an embodiment of the present invention.

Referring to FIG. 2, in order to share a risk status of a user, the server 200 may include a data communication unit 201 for transmitting and receiving data through the Internet, a timer control unit 202 for determining whether a timer of a user terminal is executed or terminated, an interactive interface control unit 203 for providing an interactive interface to the user terminal to display one or more questions or guidance information to the user and for collecting context information of the user using the user's reply content which is input as a response thereto, and an online chat room control unit 204 for providing an online chat room, in which online chatting between the user terminal and a recipient terminal may be performed while the timer is executed, to the user terminal.

The data communication unit 201 includes a function of transmitting and receiving data through a dedicated line or a wired and/or wireless Internet. Pieces of data which are input through the Internet include safety status information of the user, information of predetermined conditions associated with timer execution, and information such as the user's reply content which is input to the interactive interface. Pieces of output information include a timer execution notification message, information of the online chat room, and a risk status sharing message.

In addition, in the present invention, a database (DB) 205 for storing the data collected or transmitted by the above-described respective configurations may be further included. A detailed description thereof will be described below. Here, in addition to the DB 205, although not shown, other database(s) required in association with the present invention may be additionally included.

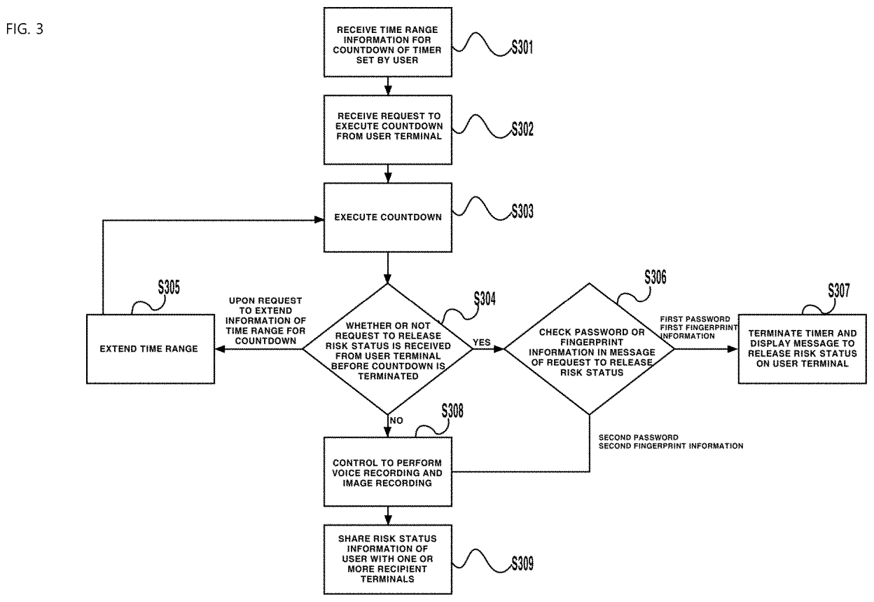

FIG. 3 is a flowchart for describing a method of sharing a risk status of a user by using a timer according to an embodiment of the present invention.

Referring to FIG. 3, the method of sharing a risk status of a user by using a timer according to the embodiment of the present invention may be performed by a server and a user terminal.

In order to implement the present invention, applications including APIs or embedded software associated with the present invention may be installed in the user terminal, and the server may control the applications.

However, the method according to the embodiment of the present invention may also be implemented by a mobile device separately manufactured for implementing the method. However, hereinafter, for convenience of description, it is assumed that the method according to the present invention is performed by the server and the user terminal, but the present invention is not limited thereto. As described above, the following contents may also be realized by the mobile device. The mobile device may include an input button implemented in at least one hardware or software, and various functions of the present invention described below may be set according to the number of times the input button is clicked and the time when the input button is clicked.

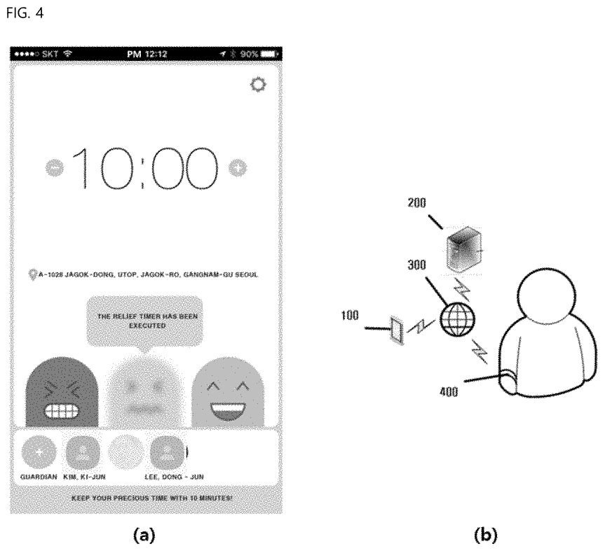

Referring again to FIG. 3, in order to implement the present invention, the user may first input information of a time range for executing a countdown of a timer through the user terminal. In this case, the time range information may be set to various ranges, such as hours, minutes, seconds, and the like. It can be confirmed that, for convenience of understanding, FIG. 4 shows an example of the timer and FIG. 4A shows a timer with time range information which is set to ten minutes.

Meanwhile, the server may receive the time range information set by the user from the user terminal, and the time range information may be information for the countdown of the timer.

When the server receives a request to execute a countdown of the timer from the user terminal after the input time range is set in the timer, the server may execute the countdown of the timer during the time range (S301 and S302).

In this case, when the time range is set to ten minutes, the countdown may start from 10:00 and may be subtracted in units of one second, e.g., 09:59, 09:58, 09:57, or 09:56, until the countdown reaches 00:00.

Meanwhile, the request to execute the countdown required for the countdown to be executed may be transmitted from the user terminal to the server when the user performs a separate input for the request to execute the countdown. In addition, when a predetermined criterion is satisfied, the request to execute the countdown may be transmitted to the server by the user terminal even when there is no separate input by the user.

That is, the request to execute the countdown may be transmitted to the server according to the input by the user. This may be regarded as the case in which the user executes the timer as a measure to protect himself or herself in a situation that the user feels that a crime may occur in the near future.

For example, the situation may include a situation in which the user has to walk in a dark alleyway, a situation in which the user has to go home at night by taxi, a situation in which the user has to enter a public toilet, a situation in which the user perceives that someone is following, a situation in which the user has to get in or out of a car in a place where there are not many people, a situation in which a visitor whose identity is difficult to check comes to a home, or the like.

Meanwhile, when the user enters an input for executing the countdown of the timer through the user terminal, the request to execute the countdown may be transmitted to the server, and thus the server may execute the timer and control such that the countdown may be executed during the time range pre-input by the user.

Further, the request to execute the countdown may be transmitted to the server even when the predetermined criterion is satisfied as described below.

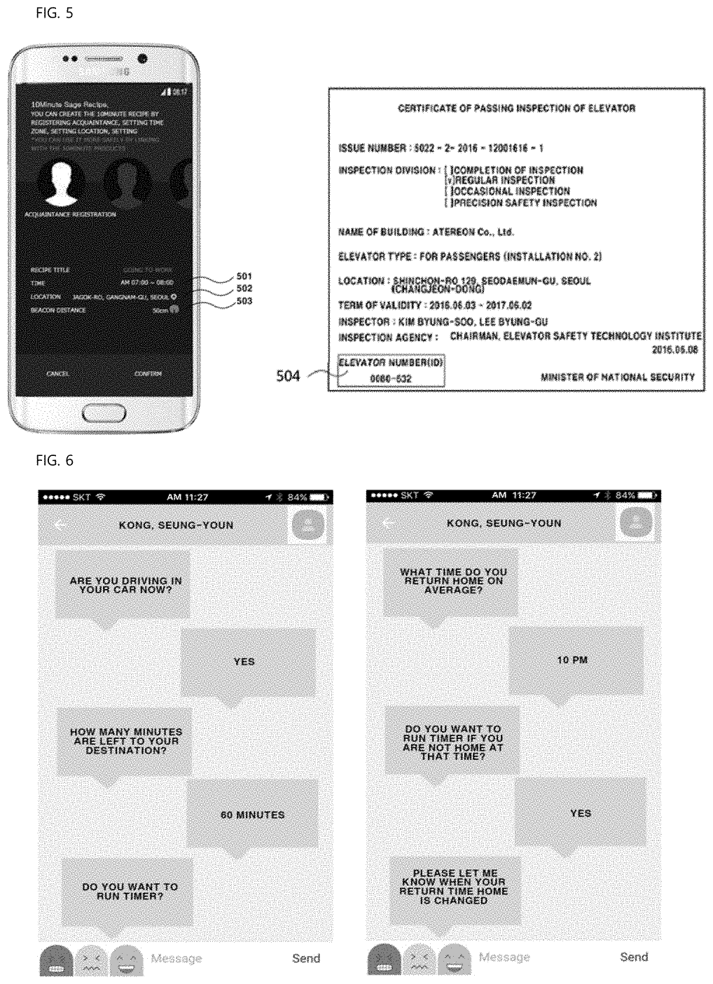

Referring to FIG. 5A, a screen for setting a predetermined criterion in which a request to execute the countdown may be transmitted is shown as a method of executing a countdown of a timer according to an embodiment of the present invention. However, the screen may vary according to the setting, and an important factor is that various conditions for executing the countdown of the timer may be set.

That is, as shown in FIG. 5A, in the present invention, criteria or conditions may be set in advance so that the request to execute the countdown may be automatically transmitted even when the user does not input any additional information at a moment of predicting a predetermined risk.

In this case, the predetermined criteria that can be set may include any one of (1) a case 501 in which a preset specific time is reached, (2) a case 502 in which the user terminal enters a preset specific place (or the case in which, when the preset specific place is set as a reference point, the preset specific place is within a certain range from the reference point), (3) a case in which, after a preset external device and the user terminal are in communication with each other, an interval between the external device and the user terminal is increased by a predetermined range, (4) a case 503 in which the user terminal receives a signal (e.g., a beacon, a Bluetooth signal, a Quick Response (QR) code recognition signal, etc.) of the preset external device, (5) a case in which a sudden speed change (e.g., a change in speed of 50 km or more per minute occurs within one minute) occurs, (6) a case in which the user terminal is shaken a predetermined number of times and/or in a predetermined direction, and (7) a case in which there is a request from another user who has a friend relationship with the user in the application installed in the user terminal. However, the above predetermined criteria are illustrative, and criteria or conditions for allowing the request to execute the countdown to be transmitted by another method may be set.

In this case, the external device may be a device installed in a specific place having a narrow exposure range from a viewpoint of a person, such as an elevator, an alleyway, a taxi, a public toilet, or the like, or may be a device installed in a preset specific region. The external device may be a device or a tool capable of performing data communication with the user terminal through a communication signal, such as a Bluetooth signal, a beacon signal, or a QR code signal.

Therefore, in the case in which the user of the user terminal enters a specific place, which is classified as, for example, a dangerous region, in which the external device is installed, when the user terminal receives a communication signal from the external device, the request to execute the countdown may be set to be automatically transmitted by the user terminal.

Further, in the case in which the user of the user terminal passes the specific place at which entry into the place classified as a dangerous region may be expected, when an interval between the user terminal and the external device is increased by a predetermined range after the external device installed in the specific region and the user terminal are in communication with each other, the request to execute the countdown may be set to be automatically transmitted through the user terminal.

This is because, when the interval between the user terminal and the external device is increased by the predetermined range, the user of the user terminal may be expected to enter the specific place classified as the dangerous region.

In this case, according to the embodiment of the present invention, the external device may include a unique identification (ID) number. For example, when the external device is attached to an elevator, a unique number 504 of the elevator may be set to be the unique ID number of the external device, as shown in FIG. 5B.

Therefore, in the present invention, when a request to release the risk status of the user is not input until the timer is terminated so that the risk status information of the user is shared with one or more recipient terminals, the unique ID number of the external device may be transmitted to the one or more recipient terminals together with the risk status information of the user.

As described above, the reason why the unique ID number of the external device is included will be described below.

For example, in a situation in which the request to release the risk status of the user is not input until the timer is terminated, that is, in a situation in which the user (or the user terminal) is in the risk status, when the user is outside, location information of the user terminal identified through a Global Positioning System (GPS) or the like may be included in the risk status information of the user and may be shared with the one or more recipient terminals. In this case, the recipient terminals may easily grasp a current location of the user.

However, when the user in the risk status is inside, the location information of the user terminal may not be accurately grasped through the GPS or the like. In this case, even when the one or more recipient terminals receive the risk status information of the user, it may be difficult for the recipient terminals to easily grasp the current location of the user.

Therefore, in the present invention, the unique ID number of the external device is transmitted together with the risk status information of the user so that the recipient terminals may be accurately grasped even when the user (or the user terminal) in the risk status is inside.

Ultimately, in the present invention, criteria or conditions may be set in advance so that the request to execute the countdown may be automatically transmitted even when the user does not enter another input at a moment of predicting a predetermined risk and may be set differently for each of one or more users utilizing the present invention.

Meanwhile, referring again to FIG. 4, FIG. 4B shows a wearable device 400 (e.g., a biological signal measurement device or the like) which can be worn by the user.

Although not separately shown in FIG. 4B, the biological signal measurement device 400 of the present invention may include a biological signal measurement unit, a wireless communication unit, a location measurement unit, a control unit, and a manual input unit and may further include a frame for allowing the biological signal measurement device 400 to be worn on the user's body. Further, according to the embodiment of the present invention, the components of the biological signal measurement device 400 may be omitted, or the biological signal measurement device 400 may further include another component.

Meanwhile, the biological signal measurement unit of the biological signal measurement device 400 may sense or detect biological signals of the user and, to this end, may generate signals for sensing the biological signals.

Here, the biological signals of the user may include the user's heart rate, body temperature, skin condition, blood oxygen level, etc., and may further include all biological signals which can be measured by a sensing unit.

Further, the biological signal measurement unit may include a gyro sensor, an acceleration sensor, a proximity sensor, a pressure sensor, a motion sensor, a fingerprint sensor, an iris recognition sensor, a heart rate measuring sensor (a heart rate detection sensor), a body temperature sensor, a skin condition measuring sensor (a skin temperature measuring sensor), a skin resistance sensor, an electrocardiogram sensor, an internal blood oxygen measuring sensor (a blood oxygen level measuring sensor), and the like.

However, hereinafter, for convenience of description, it is assumed that the biological signal measurement unit includes a heart rate measuring sensor for measuring a heart rate of a user, an acceleration sensor for measuring movement of the user and a movement speed thereof, a body temperature measuring sensor for measuring a body temperature of the user, and a skin condition measuring sensor for measuring a skin condition of the user.

In an embodiment of the present invention, the biological signal measurement device 400 may measure the biological signals of the user wearing the biological signal measurement device through the biological signal measurement unit.

For example, when the user wearing the biological signal measurement device is exposed to a crime scene, the heart rate measuring sensor of the biological signal measurement device may measure a change in the heart rate of the user changed due to the crime, and the heart rate measuring sensor may measure a change in the heart rate of the user due to the crime by determining a change in a resistance value.

Further, when the user's breathing is disturbed due to the crime or the user experiences difficulty in breathing due to a criminal act such that a sudden change in an amount of oxygen present in the user's body occurs, the blood oxygen level measuring sensor may measure a change amount of the oxygen.

Further, when the user's skin is injured or excessive bleeding occurs, the skin condition measuring sensor in the biological signal measurement device may measure a skin condition of the user.

Meanwhile, the biological signal measurement device 400 may determine a biological status of the user using the measured biological signals of the user.

More specifically, the biological signal measurement device may compare a value indicated by a biological status result of the user in a normal state with a value indicated by a biological signal of the user which is measured every predetermined period and determine whether a difference between the value indicated by the biological signal of the user and the value indicated by the biological status result in the normal state is greater than or equal to a predetermined value to determine the biological status of the user.

Here, the determination of the biological status of the user may refer to a process of determining whether a body temperature, a heart rate, a skin condition, and the like of the user, which can be measured when the user is in a normal state, are changed to a predetermined risk level according to a change in environment around the user and may be implemented by the control unit of the biological signal measurement device.

Meanwhile, the biological signal measurement device, which determines the biological status of the user, may generate an alarm signal including the biological signal of the user when a change in the sensed or measured biological signal of the user is sensed.

The generated alarm signal may be transmitted to external devices (e.g., all devices capable of being connected to the biological signal measurement device, such as the server or the user terminal of the present invention) through a wireless communication unit (or a communication modem). In this case, the transmission of the alarm signal may be performed using a local communication module or a wireless Internet module and, in particular, the alarm signal may be transmitted using a Bluetooth Low Energy (BLE) beacon included in the biological signal measurement device.

Further, the biological signal measurement device may include the location measurement unit, and the location measurement unit may perform location measurement of the user of the biological signal measurement device using a GPS or BLE under the control of the control unit and may transmit a result of the performance through the wireless communication unit.

The alarm signal including the biological signal of the user, which is transmitted to the external devices by the above process, and the location information may trigger the execution of the timer according to the embodiment of the present invention.

Meanwhile, the biological signal measurement device according to the embodiment of the present invention may be implemented in various forms, such as a wearable device in the form of a wrist band, a wearable device in the form of glasses, an external remote controller, a bracelet, and a ring, and it is to be understood that this is merely illustrative, and the biological signal measurement device can be implemented in any form.

Meanwhile, when the predetermined condition is satisfied as described above, the timer may be automatically executed by the server even when the user's command for executing the timer is not input. According to the embodiment of the present invention, two or more predetermined conditions may be set, and the timer may be set to be executed only when at least one of the conditions is satisfied.

Meanwhile, according to the embodiment of the present invention, the server may display at least one predetermined question or guide information to the user using an interactive interface.

Referring to FIG. 6, the server may provide the interactive interface (e.g., a chatbot) to the user terminal, wherein the interactive interface may be a robot for chatting. A left dialog box of FIG. 6 represents the question or guide information provided in the interactive interface, and a right dialog box represents the user's reply content for input through the user terminal.

The interactive interface is a system for providing a predetermined question or guide information to the user terminal and being adapted to respond to the reply of the user according to a predetermined response rule.

The interactive interface has a request-response structure between the server and the user terminal which provide an interactive interface. When the server or the user inputs a specific message in a messenger dialog box, the other party may appropriately response in response to the message.

Meanwhile, in addition to a method of transmitting only simple text through the interactive interface, videos, images, website addresses (Uniform Resource Locator (URL)), etc. may be transmitted or received singly or in combination through the interactive interface.

In the present invention, the server may collect context information of the user using the reply contents which are input by the user through the interactive interface and determine whether the timer is executed based on the collected context information.

Meanwhile, when the timer is executed according to the various methods described above, the server may transmit a notification message informing a guardian terminal which is preset by the user terminal that the timer of the user has been executed.

In the present invention, the user terminal may set at least one recipient terminal to which the notification message and a risk status message to be described below will be transmitted.

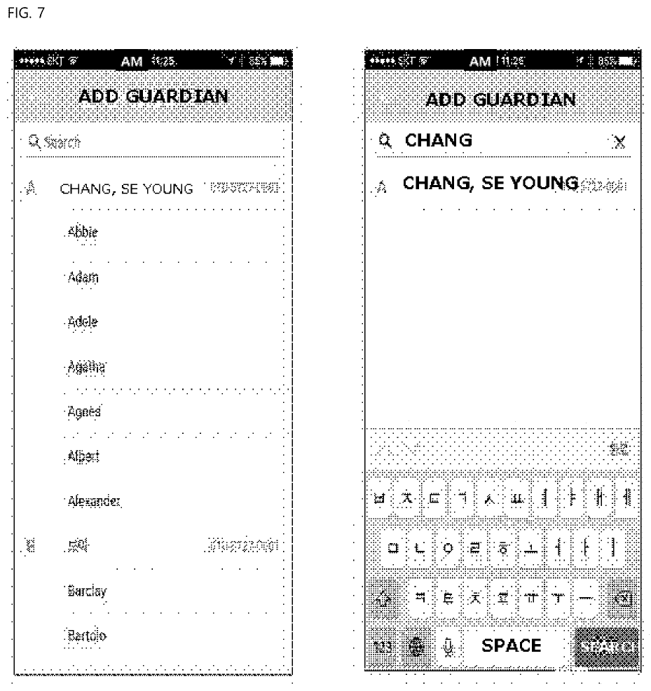

The recipient terminal may be set by searching for and inputting a specific user whose name is stored in a telephone directory by the user of the user terminal, as shown in FIG. 7, or may be set using various methods that can specify other user terminals.

Further, the notification message, which is transmitted to the recipient terminal determined as described above, may include at least one of time information (e.g., 11:03 PM) in which the execution of the timer is executed, execution time range information (e.g., ten minutes) of the timer, and end time information (e.g., 11:09 PM) of the timer.

Meanwhile, when the timer is executed according to the various methods described above, the server may transmit the notification message informing the recipient terminal that the timer of the user has been executed.

In the present invention, the user terminal may set at least one recipient terminal to which the notification message and a risk status message to be described below will be transmitted, and the notification message, which is transmitted to the set recipient terminal, may include at least one of time information (e.g., 11:03 PM) in which the execution of the timer is executed, execution time range information (e.g., ten minutes) of the timer, and end time information (e.g., 11:09 PM) of the timer.

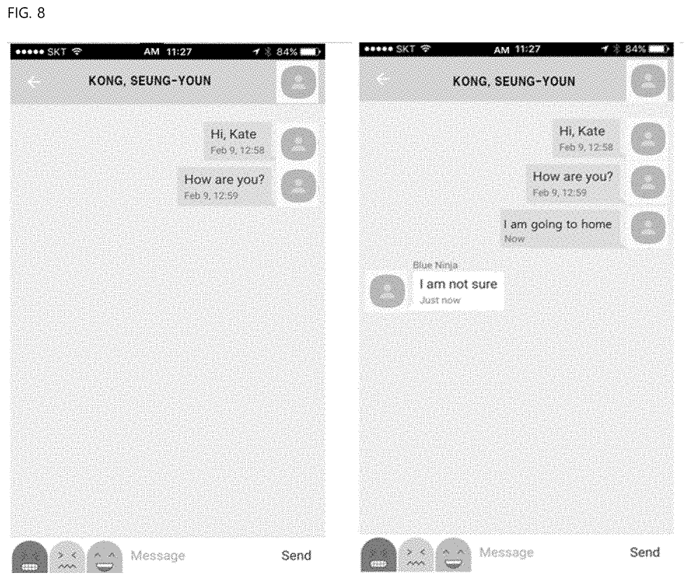

In the present invention when the timer is executed, the server may establish an online chat room in which online conversation is performed between the user terminal and the recipient terminal, as shown in FIG. 8.

The user terminal and the recipient terminal may chat through the opened online chat room, and the user terminal, which receives messages from the recipient terminal through the established online chat room, may respond by clicking a button or transmitting a reply message to the recipient terminal.

Meanwhile, according to the present invention, as described above, the timer may be executed in advance at a moment of entering user's input or at a moment of predicting a risk according to a predetermined criterion, and the risk status information of the user may be shared with a third party when there is no request to release the risk status of the user until the timer is terminated.

Generally, there may be a realistic difficulty for a victim to seek help from another person in an urgent and confusing situation where a crime is occurring. According to the present invention, even when the user does not or cannot execute a certain action (e.g., screaming, calling a phone, clicking a rescue request button, requesting help, etc.) in an urgent situation in which a crime is occurring, there may be a special effect that external help can be requested in real time when it is assumed that the case in which a crime does not occur is a release condition.

Meanwhile, when the server does not receive the request to release the risk status from the user terminal until the countdown is terminated after the countdown of the timer is executed, the server may share the risk status information of the user with at least one predetermined recipient terminal (S309).

In this case, the recipient terminal sharing the risk status information of the user may be a terminal of a safety agency including at least one of a police station, a fire department, and a medical institution. In addition, the recipient terminal may further include a terminal of at least another user (e.g., a family member, a friend, a relative, a boyfriend, etc.) which is preset by the user, as described with reference to FIG. 7.

That is, in the present invention, the user may register a terminal of the safety agency and a terminal of an acquaintance of the user in advance, with which the risk status information of the user may be shared, as recipient terminals.

Further, according to the embodiment of the present invention, when the server does not receive the request to release the risk status from the user terminal until the countdown is terminated from a time point when the countdown was executed, the server may control the voice recording function and the image recording function of the user terminal to be executed (S308).

In this case, the risk status information of the user shared with the at least one predetermined recipient terminal may include voice information and image information (e.g., video information and/or picture information) generated according to the execution of the voice recording function and the image recording function, and the location information of the user terminal.

Here, the location information of the user terminal may include information measured using the GPS information of the user terminal, as described above, but the present invention is not limited thereto, and the location information of the user terminal may include information measured through an access point (AP) connected to the user terminal.

According to the embodiment of the present invention, the location information of the user terminal may include one or more pieces of location information. According to the embodiment of the present invention, the location information of the user terminal may include (1) location information of the user terminal measured at a time point when the user terminal of the timer is executed, and (2) location information of the user terminal at a time point (or immediately before the transmission) when the risk status information is transmitted from the user terminal to the at least one recipient terminal.

In the present invention, each of the one or more pieces of location information may be location information measured by different measurement methods according to the setting. Further, each of the one or more pieces of location information may be individually transmitted to the one or more predetermined recipient terminals each time the measurement is made or may be transmitted at once including all of the one or more pieces of measured location information at a time point when the risk status information is transmitted from the user terminal to the one or more recipient terminals.

Further, each of the one or more pieces of location information may be set so that all or a part of each of the one or more pieces of location information is transmitted to the same recipient terminal or different recipient terminals at each of measurement and transmission time points.

In the present invention, the reason why the one or more pieces of location information may be set to be transmitted to the recipient terminal is as follows.

For example, when only the measured location information of the user terminal is transmitted to the recipient terminal at a specific time point at which the risk status information of the user is shared, and when the user terminal (or the user) is in a place (e.g., an indoor, an elevator, a underground parking lot, etc.) in which accurate location measurement is difficult, the location information of the user terminal shared with the recipient terminal may be less accurate such that it may be difficult for smooth follow-up actions such as rescue actions to be performed.

Further, as shown in FIG. 10, there may be a certain distance between a place 1001 at which the user which first perceives a risk status or is placed in a first risk status and a place 1002 in which the risk status information of the actual user is shared according to various external circumstances (e.g., abduction by car, etc.).

Therefore, as described in the embodiment of the present invention, when all of (1) the location information of the user terminal measured at a time point when the user terminal of the timer is executed and (2) the location information of the user terminal at a time point (or immediately before the transmission) when the risk status information is transmitted from the user terminal to the one or more recipient terminals are transmitted to the recipient terminal, the location of the user terminal may be grasped more accurately, and the movement speed, the movement path, and the like of the user terminal (or the user) in the risk status may be tracked so that follow-up actions such as rescue actions may be smoothly performed.

Further, according to the embodiment of the present invention, when the server does not receive the request to release the risk status from the user terminal until the countdown is terminated from the time point when the countdown was executed, the server may control a danger notification sound with a predetermined intensity so as to be heard through the user terminal.

In this case, the predetermined intensity of the danger notification sound may be set to an intensity of 86 decibels (dB) or higher, but the present invention is not limited thereto, and the predetermined intensity may vary according to the setting of the user.

Meanwhile, according to the embodiment of the present invention, when the countdown of the timer is executed, the server may transmit information indicating that the countdown of the timer has started to another terminal of the user which is preset in advance by the user.

The another user terminal which has received the information indicating that the countdown of the timer has started may transmit a status sharing request message through the server or directly to the user terminal or may transmit a message by establishing an online chat room. In this case, a predetermined time range may be additionally set.

In this case, the user terminal which receives the status sharing request message or the message through the online chat room may perform a response with respect to a request to share a status by clicking a button or transmitting a reply message to another user terminal.

However, when no response is transmitted from the user terminal until a predetermined time has elapsed, the server may share the risk status information of the user with at least one recipient terminal including another user terminal.

Meanwhile, according to the embodiment of the present invention, when the server receives the request to share the risk status information (or a request to notify the risk status information) from the user terminal before the countdown of the timer is terminated after the countdown of the timer is executed, the server may share the risk status information of the user with the at least one predetermined recipient terminal.

That is, when the user recognizes or is sure that he or she has already been placed in the risk status before the countdown of the timer is terminated after the countdown of the timer is executed, the risk status information needs to be shared more rapidly. Therefore, when the user has a request even before the countdown of the timer is terminated, the risk status information of the user may be shared with the one or more predetermined recipient terminals.

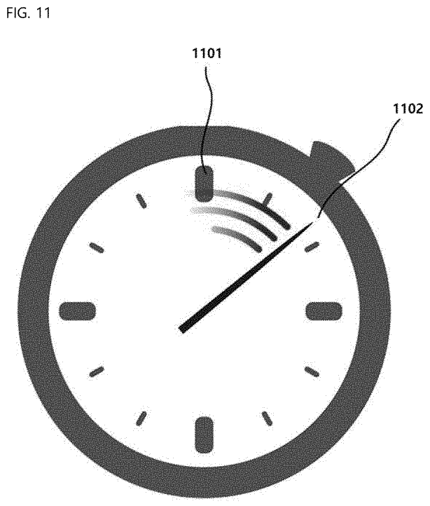

For example, as shown in FIG. 11, when it is assumed that the timer is set at one minute, which is a time required for the timer to start from a location 1101 of an hour hand at 12 o'clock and then return back to the location 1101 of the hour hand at 12 o'clock, the risk status information of the user may be set to be shared with the one or more recipient terminals only when the request to release the risk status is not received from the user terminal until the countdown of the timer is terminated after the countdown of the timer is executed. In addition, even when the timer still has 50 seconds before the countdown of the timer has been terminated, that is, even when the timer approaches a location 1102 of an hour hand at 2 o'clock until the countdown is terminated, the risk status information of the user may be shared with the one or more predetermined recipient terminals when there is a request from the user.

Conventionally, as described above, there also have been small-sized rescue request devices for allowing a user (or a victim) who is in an emergency situation to request help from another person. Such devices often cause a rescue request to be transmitted to an external recipient terminal even when the user mistakenly pressed a button or the like for the rescue request by mistake, and thus, often, situations occur in which erroneous rescue requests are transmitted. Accordingly, even when there is a real rescue request after repeated mistakes, it is handled as an erroneous rescue request, and there is a serious problem that the rescue is not performed even in a situation in which the actual rescue is necessary.

However, in the embodiment of the present invention, when the user has a separate request to share the risk status information while the timer is running, the risk status information of the user is shared with the external recipient terminal at that time, and thus it may further include a prerequisite that the timer should be executed before the risk status information is shared with the external device in response to the request by the user.

Therefore, it is possible to prevent an occurrence of an operation of informing the external receiver terminal of the risk status as a simple operation mistake by the user, and thus it is possible to reduce errors as compared with the conventional rescue request device in which no timer function is present.

Further, according to the embodiment of the present invention, as a method for the user to separately request to share a risk status information while the timer is running, there may be various methods, such as a method of clicking a preset button, a method of shaking the user terminal in a predetermined number of times and/or in a predetermined direction, a method in which there is a voice expression for a predetermined word (e.g., “help me,” “save me,” “rescue me,” etc.), and a method of leaving from a predetermined path that can be set when the timer is executed. In addition, the method for the user to separately request to share the risk status information may be performed by various methods according to the setting.

Meanwhile, when the server receives the request to release the risk status from the user terminal before the countdown is terminated after the countdown of the timer is executed, the server may control the user terminal of the timer to be terminated. In this case, the server may display a risk release message notifying the user terminal that the risk status has been released simultaneously with the termination of the timer.

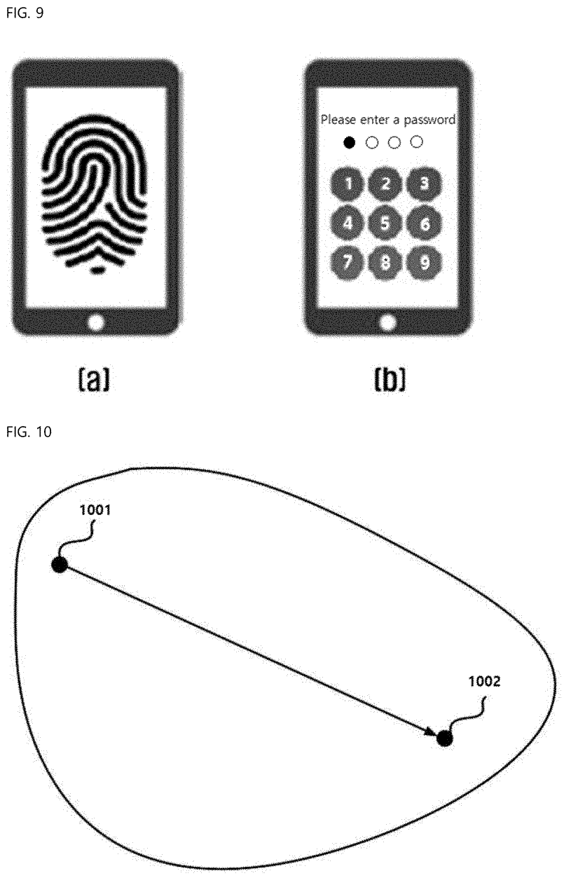

Further, in the present invention, as shown in FIGS. 9A and 9B, the request to release the risk status may further include at least one of password information or fingerprint information of the user. According to the embodiment of the present invention, the password information may include a plurality of pieces of password information, such as first password information and second password information, and the fingerprint information may also include a plurality of pieces of fingerprint information, such as first fingerprint information and second fingerprint information.

Hereinafter, a more specific example will be described in order to facilitate understanding. It is assumed that the user sets the first password information to 1004, the first fingerprint information about a fingerprint of a left thumb finger, the second password information to 2580, and the second fingerprint information about a fingerprint of a right index finger.

In this case, although a crime situation has occurred to the user, the first password or the first fingerprint information may be preset to be interpreted to be recognized as indicating to the user that no other crime has occurred, or the second password or the second fingerprint information may be preset to be interpreted to be recognized as requesting sharing of the risk status information of the user to an external recipient terminal because the user is being threatened by the perpetrator. However, this is an example only and may be changed according to the setting, and a larger number of pieces of password information or fingerprint information may be set.

Therefore, according to the embodiment of the present invention, when at least one of the first password information and the first fingerprint information is included in the request to release the risk status and transmitted to the server, the server may recognize or handle the user as if no other crime has occurred, control the user terminal of the timer to be terminated, and display the risk release message notifying that the risk status has been safely released on the user terminal.

Meanwhile, according to an embodiment of the present invention, when a request to extend the information of the time range for the countdown is transmitted before the countdown is terminated, the server may recognize or handle the request as if no other crime has occurred to the user and extend the time range information for the countdown of the timer. In this case, the time range information may be set to extend only when the request to extend the time range information is transmitted together with at least one of the first password information and the first fingerprint information.

Further, the extending time range may be a preset range of time (e.g., one minute). However, when the user transmits the request to extend the time range information including a desired extend time range (e.g., three minutes), the time range may extend by the corresponding time range (three minutes).

However, when at least one of the second password information and the second fingerprint information is included in the request to release the risk status and transmitted to the server, the server may recognize or handle the user as occurrence of a crime and be set to share the risk status information of the user with at least one predetermined recipient terminal.

In this case, the server may share the risk status information of the user with the one or more predetermined recipient terminals, control the user terminal of the timer to be terminated, and control the risk release message notifying that the risk status has been safely released to be displayed on the user terminal.

As described above, in the present invention, the password information and the fingerprint information of the user that can be included in the request to release the risk status may be provided in the forms of a plurality of pieces of information, and a reason for setting different processes according to each of them is as follows.

That is, when it is assumed that a crime occurs, the user of the user terminal may correspond to a victim and thus may be physically or mentally threatened by the perpetrator of the crime.

In this case, when the perpetrator is aware that the timer is executed and forces the user to input the request to release the risk status, the user will inevitably be forced to input the request to release the risk status. Further, in this case, the user will not be able to make any outside help requests and will eventually be harmed by the perpetrator.

However, as described in the embodiment of the present invention, when the password information and the fingerprint information of the user that can be included in the request to release the risk status may be provided in the forms of a plurality of pieces of information and may be set to perform different processes according to each of the password information and the fingerprint information, the above problem may be solved.

That is, even when the user is forced to input the request to release the risk status by the perpetrator as described above, it is possible to reassure the perpetrator by inputting the second password information and, at the same time, there is an effect that the risk status information of the user may be shared with at least one predetermined recipient terminal without being exposed to the perpetrator.

In the present invention, after the timer operates, when the timer is continuously operated because the safety status information is not received from the user terminal until a predetermined time during which the timer operates has elapsed, the server may transmit a risk status sharing message notifying a preset guardian terminal of the risk status information of the user (S304 and S305).

However, when the safety status information is input from the user terminal before the predetermined time during which the timer operates has elapsed, the server may set the online chat room to be closed and terminate the timer by determining whether the user terminal is in a safe state (S306).

However, when the safety status information is not input from the user terminal until the predetermined time has elapsed, the server may transmit the risk status message of the user to one or more of recipient terminals including the guardian terminal (S305).

In this case, the one or more recipient terminals, which share the risk status message of the user with the guardian terminal, may include a terminal of a safety agency including at least one of a police station, a fire department, and a medical institution, and at least another guardian terminal which is preset by the user.

Meanwhile, in the present invention, when the safety status information is input from the user terminal before the predetermined time during which the timer operates has elapsed, the server may set the online chat room to be closed.

The safety status information may include the password information (e.g., a four-digit password, etc.) of the user or may include various pieces of information such as fingerprint information.

According to the embodiment of the present invention, in the password information, a plurality of passwords based on first password information and second password information may be set and, in the fingerprint information, a plurality of fingerprints based on first fingerprint information and second fingerprint information may be set.

Hereinafter, a more specific example will be described in order to facilitate understanding. It is assumed that the user sets the first password information to 1004, the first fingerprint information to a fingerprint of a left thumb finger, the second password information to 2580, and the second fingerprint information to a fingerprint of a right index finger.

In this case, the first password or the first fingerprint information may be preset to be recognized as an interpretation to indicate to the user that no other crime has occurred, or although a crime situation has occurred to the user, the second password or the second fingerprint information may be preset to be recognized as an interpretation for requesting sharing of the risk status information of the user to the guardian terminal because the user is being threatened by the perpetrator. However, this is an example only and may be changed according to the setting, and a larger number of pieces of password information or fingerprint information may be set.

Therefore, according to the embodiment of the present invention, when at least one of the first password information and the first fingerprint information is input as the safety status information and transmitted to the server, the server may recognize or handle the user as if no other crime has occurred, control the timer of the user terminal to be terminated and/or the online chat room to be closed, and display the risk release message notifying that the risk status has been safely released, on the user terminal.

As described above, in the present invention, the password information and the fingerprint information of the user that can be included in the safety status information may be provided in the form of a plurality of pieces of information, and a reason for setting different processes according to each of them is as follows. That is, when it is assumed that a crime occurs, the user of the user terminal may correspond to a victim and thus may be physically or mentally threatened by the perpetrator of the crime.

In this case, when the perpetrator is aware that the timer is executed and forces the user to enter the safety status information, the user will inevitably be forced to input the safety status information. Further, in this case, the user will not be able to make any extra outside help requests and will eventually be harmed by the perpetrator.

However, as described in the embodiment of the present invention, when the password information and the fingerprint information of the user that can be included in the safety status information may be provided in the forms of a plurality of pieces of information and may be set to perform different processes according to each of the password information and the fingerprint information, the above problem may be solved.

That is, even when the user is forced to enter the safety status information by the perpetrator as described above, it is possible to reassure the perpetrator by inputting the second password information and, at the same time, there is an effect that the risk status of the user may be shared with at least one predetermined guardian terminal without being exposed to the perpetrator.

Meanwhile, according to the embodiment of the present invention, the risk status sharing message may be a short message service (SMS) message including web-link information for connecting the risk status sharing message to a web page displaying the risk status information of the user.

Therefore, according to the present invention, the risk status information may be provided to the guardian terminal in the form of an SMS message including web-link information. In this case, the risk status information of the user may be safely shared with a guardian terminal that is not subscribed to a service, or a guardian terminal to which second generation (2G) mobile telecommunication technology is applied in which a mobile instant message cannot be transmitted.

In the present invention, with regard to the case in which a guardian or a person to be protected is added, the case in which the user to be protected executes a timer, the case in which the user to be protected checks safety after the timer is executed, the case in which the user to be protected cannot check the safety before the timer is terminated after the timer is executed, and the case in which the user to be protected checks the safety after a risk is notified, a message for each of the above cases may be transmitted in the form of a push notification or an SMS according to whether the guardian and/or the user to be protected is a subscriber or a non-subscriber to an application or service in which the present invention is applicable.

Meanwhile, according to the embodiment of the present invention, as shown in Table 1, one or more scenarios including at least one designated item may be preset.

TABLE 1

| Scenario types | Designated items | Setting values |
|---|---|---|
| On night | 1. Timer time | 1. Ten minutes |
| rode or at | 2. Position information | 2. GPS (automatically) |
| strange place | 3. Safety status check cycle | 3. Every one minute |
| | 4. Guardian terminal | 4. Parents, spouse, etc. |
| In taxi | 1. Timer time | 1. Estimated arrival time |
| | 2. Taxi information | 2. GPS (automatically), |
| | 3. Safety status check cycle | car number |
| | 4. Guardian terminal | 3. Every ten minutes |
| | | 4. Parents, spouse, etc. |
| At home | 1. Timer time | 1. Three minutes |
| alone | 2. Home address | 2. GPS (automatically), |
| | 3. Safety status check cycle | input home address |
| | 4. Guardian terminal | 3. Every one minute |
| | | 4. Security office, |
| | | neighborhood friends, etc. |
| At parking | 1. Timer time | 1. Five minutes |
| lot | 2. Parking lot information | 2. GPS (automatically), |
| | 3. Safety status check cycle | parking lot photograph |
| | 4. Guardian terminal | 3. When timer is terminated |
| | | 4. Parents, spouse, etc. |
| In elevator | 1. Timer time | 1. Five minutes |
| | 2. Elevator information | 2. GPS (automatically), |
| | 3. Safety status check cycle | unique number |
| | 4. Guardian terminal | 3. Every one minute |
| | | 4. Security office, parents, |
| | | spouse, etc. |
| In public | 1. Timer time | 1. Ten minutes |
| toilet | 2. Toilet information | 2. GPS (automatically), |
| | 3. Safety status check cycle | direct input |
| | 4. Guardian terminal | 3. Every one minute |
| | | 4. Same-sex friend, etc. |

In the present invention, when the user selects any one of the above scenarios, or when conditions which are set corresponding to each of the scenarios are achieved, the timer may be executed or the risk status sharing message may be transmitted according to the selected scenario or at least one designated item included in the scenario corresponding to the achieved conditions.

In this case, as shown in Table 1, the designated items may include a timer operating time range, a safety status check cycle of the user, contents of location information of the user which will be included in the risk status sharing message, and contents of the guardian terminal to which the risk status sharing message will be transmitted. However, this is an example only and the designated items may vary according to the setting.

Meanwhile, the technical features of the present invention described above may be achieved by an application including APIs or embedded software installed in the user terminal.

In this case, in order for the user of the user terminal to use the present invention, it may be presupposed that the user has to perform membership registration in advance with respect to the application controlled by the server as necessary. However, this may vary according to the setting.

In this case, the membership registration may include a process of inputting/authenticating at least one piece of information (e.g., a personal profile including an ID and a password) requested by the application. Alternatively, the membership registration may be performed by a method in which at least one piece of information is automatically input by being in communication with information of the user who is pre-registered on a social network service or a portal service which is linked with the application in advance according to the selection of the user.

Meanwhile, when the user performs membership registration on the application, a basic time (e.g., sixty minutes) for inputting information of a time range for a countdown of the timer may be provided to the user.

As described above, in order to implement the present invention, the user may input the information of the time range for the countdown of the timer to the server through the user terminal (or an application installed in the user terminal). In this case, the time range information may be input within a range of the basic time.

In order for the user to input the time range information in a range exceeding the basic time, the user may need to purchase (e.g., 1 USD for ten minutes, 1,000 KRW for ten minutes, etc.) an additional time by performing a separate payment in the application or to receive (e.g., as a present, etc.) an additional time from another user subscribed to the application. In addition, when the user completes a specific mission (e.g., when the user views contents (advertisement or the like) provided by the application, when the attendance is recognized by executing the application every predetermined period, or when another user performs a membership registration for the application by recommending another user), a predetermined additional time may be set to be provided.

Meanwhile, as described above, when the server receives the request to execute the countdown of the timer from the user terminal, the server may execute the countdown of the timer during the time range and, in this case, the subtraction by a range from the basic time to the additional time may be performed corresponding to the counted down time range.

However, when a request to extend the information of the time range for the countdown is transmitted to the server before the countdown is terminated, the information of the time range for the countdown of the timer may extend and, in this case, the extension time, which is the extended time range, may be set so that there is no subtraction in a range from the basic time to the additional time.

Meanwhile, in the application installed in the user terminal, the user may form a certain relationship (e.g., a friend relationship, a first degree relationship, a follower, a followee, etc.) with other users subscribed to the application, the user may search for other users within the certain relationship to set at least one of the searched other users as a recipient terminal with which the risk status information of the user can be shared, and the user may check and share the remaining amount such as the basic time and the additional time, the usage history, etc., with the recipient terminal.

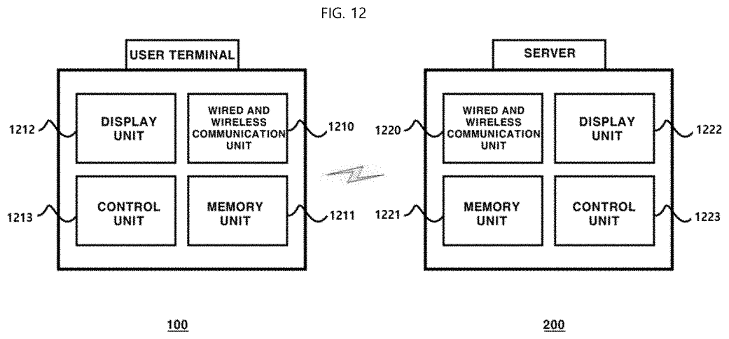

FIG. 12 shows block diagrams of configurations of a user terminal and a server to which an embodiment of the present invention can be applied.

Referring to FIG. 12, a user terminal 100 and a server 200 that may be applied in the present invention are shown.

The server 200 may include a wired and wireless communication unit (a radio communication unit) 1220 including a transmission unit and a reception unit capable of transmitting and receiving connection information necessary for wired or wireless connection, a memory unit 1221, a display unit 1222, and a control unit (or a processor) 1223. This is an example only, and the server 200 may further include another configuration other than the configurations shown in FIG. 12, or some of the configurations shown in FIG. 12 may be omitted.

Further, overall processing of the server 200 for data communication with the user terminal 100, such as signal processing, hierarchical processing, and the like, is controlled by the memory unit 1221 and the control unit 1223, and a connection relationship may be formed among the memory unit 1221, the wired and wireless communication unit 1220, and the control unit 1223.

As described above, the wired and wireless communication unit 1220 included in the server 200 may include the transmission unit and the reception unit, and the transmission unit and the reception unit may be configured to transmit and receive data or signals to and from the user terminal 100, the server 200, or at least one external device (not shown in FIG. 12).

The control unit 1223 may be functionally connected to the transmission unit and the reception unit included in the wired and wireless communication unit 1220, and thus the control unit 1223 may be configured such that the process of transmitting and receiving the data or signals between the user terminal 100 and the server 200 is controlled by the transmission unit and the reception unit.

Further, the control unit 1223 may perform various types of preprocessing on the data to be transmitted and then transmit the preprocessed data to the transmission unit and may perform post-processing on the data received by the reception unit.

If necessary, the control unit 1223 may store information included in the transmitted and received data in the memory unit 1221. With the above structure, the server 200 may perform the methods of various embodiments of the present invention described above.

Referring to FIG. 12, the user terminal 100 may include a wired and wireless communication unit 1210 including a transmission unit and a reception unit, a memory unit 1211, a display unit 1212, and a control unit 1213. Since the configuration of the user terminal 100 has been described in detail with reference to FIG. 12, a description thereof will be omitted below.

The control units 1213 and 1223 of the user terminal 100 and the server 200 may instruct (e.g., control, adjust, manage, etc.) the operations of the user terminal 100 and the server 200, and the control units 1213 and 1223 may be respectively connected to the memory units 1211 and 1221 capable of storing program codes and data.

The memory units 1211 and 1221 may be respectively connected to the control units 1213 and 1223 to store an operating system, applications, and general files.

Each of the control units 1213 and 1223 of the present invention may also be referred to as a processor, a controller, a microcontroller, a microprocessor, a microcomputer, or the like. Meanwhile, the control units 1213 and 1223 may be implemented by hardware, firmware, software, or a combination thereof.

When the control units 1213 and 1223 are implemented by firmware or software, an embodiment of the present invention may be realized in the form of a module, a procedure, a function, and the like, which perform the functions or operations described above. The software codes may be stored in the memory units 1211 and 1221 and may be driven by the control units 1213 and 1223.

In this case, the memory unit may be located inside or outside the user terminal 100 and the server 200 and may exchange data with the control units 1213 and 1223 using various well-known units.

Meanwhile, the above-described method may be written as a program that may be executed in a computer and may be implemented in a general-purpose digital computer that operates the program using a computer readable recording medium. Further, a structure of data used in the above-described method may be recorded in the computer readable recording medium through several methods. The computer readable recording medium for storing executable computer codes for performing the various methods of the present invention includes a storage medium such as a magnetic storage medium (for example, a read only memory (ROM), a floppy disk, and a hard disk), and an optical reading medium (for example, a compact disc read only memory (CD-ROM) and a digital video disc (DVD)).

It will be understood by those skilled in the art that various changes in form and details may be made without departing from the spirit and scope of the present invention. Therefore, the disclosed methods should be considered in a descriptive sense only and not for purposes of limitation. The scope of the invention is defined not by the detailed description of the invention but by the appended claims and encompasses all modifications and equivalents that fall within the scope of the appended claims and will be construed as being included in the present invention.

### INDUSTRIAL APPLICABILITY

The method of sharing a risk status of a user by using a timer and the apparatus therefor of the present invention may be applied to various methods and apparatuses sharing a risk status.

1. A method for a server to share information of a risk status of a user using a timer, the method comprising:
receiving information of a time range of a countdown of the timer set by the user from a user terminal;
executing the countdown of the timer during the time range when a request to execute the countdown of the timer is received from the user terminal; and
sharing risk status information of the user with at least one predetermined recipient terminal when a request to release the risk status is not received from the user terminal before the countdown is terminated from a time point when the countdown was executed.

2. The method of claim 1, further comprising terminating the timer and displaying a risk release message indicating that the user is released from the risk status on the user terminal when the request to release the risk status is received from the user terminal before the countdown is terminated from the time point when the countdown was executed.

3. The method of claim 2, wherein the request to release the risk status further includes at least one of password information and fingerprint information of the user,
wherein the password information includes any one of first password information and second password information, and the fingerprint information includes any one of first fingerprint information and second fingerprint information.

4. The method of claim 3, wherein:
when at least one of the first password information and the first fingerprint information is included in the request to release the risk status, the timer is terminated and the risk release message is displayed on the user terminal; and
when at least one of the second password information and the second fingerprint information is included in the request to release the risk status, the risk status information of the user is shared with the at least one predetermined recipient terminal.

5. The method of claim 4, wherein, when a request to extend time range information of the countdown is received together with at least one of the first password information and the first fingerprint information from the user terminal before the countdown is terminated from a time point when the countdown was executed, the time range information extends by a predetermined range of time.

6. The method of claim 1, wherein the recipient terminal to which the risk status information of the user is shared includes a terminal of a safety agency including at least one of a police station, a fire station, and a medical institution, and at least another user terminal which is preset by the user.

7. The method of claim 1, wherein, when the request to release the risk status is not received from the user terminal before the countdown is terminated from the time point when the countdown was executed, a voice recording function and an image recording function of the user terminal are controlled to be performed.

8. The method of claim 1, wherein the request to execute the countdown of the timer is transmitted by an input of the user or by the user terminal when a predetermined criterion is satisfied, and the predetermined criterion includes a specific time, a specific location, a speed change of a predetermined size, an arrival in the same state as that at a time point when the timer was previously operated at the user terminal, or a predetermined degree of change in a body condition of the user.

9. The method of claim 1, wherein:
at least one predetermined question or guide information is displayed to the user using an interactive interface; and
context information of the user is collected using reply content which is input by the user and the countdown of the timer is executed based on the collected context information.

10. The method of claim 1, wherein, when the countdown is executed, an online chat room in which online conversation is performed between the user terminal and the recipient terminal is established, and when safety status information is input from the user terminal before a predetermined time has elapsed, the online chat room is closed.

11. The method of claim 1, wherein the risk status information is a short message service (SMS) message including web-link information for connecting the risk status information to a web page displaying the risk status of the user.

12. The method of claim 1, wherein one or more scenarios including at least one designated item are preset,
when the user selects any one of the scenarios, the countdown of the timer is executed and the risk status information is shared according to the at least one designated item included in the selected scenario, and
the designated item includes a timer operating time range, a safety status check cycle of the user, contents of location information of the user which will be included in the risk status information, and information of the recipient terminal to which the risk status information will be transmitted.

13. An apparatus for sharing information of a risk status of a user by using a timer, the apparatus comprising:
a communication unit configured to perform data communication with one or more user terminals; and
a control unit configured to control an operation of the apparatus sharing risk status information,
wherein the control unit receives time range information of a countdown of the timer set by the user from the user terminal,
the countdown of the timer is executed during a time range of the countdown when a request to execute the countdown of the timer is received from the user terminal, and
the risk status information of the user is controlled to be shared with at least one predetermined recipient terminal when a request to release the risk status is not received from the user terminal before the countdown is terminated from a time point when the countdown was executed.
